(19) United States
(12) Patent Application Publication
(10) Pub. No.: US 2019/0108786 A1
(43) Pub. Date: Apr. 11, 2019

(54) BACKLIGHT UNIT

(71) Applicant: SAMSUNG DISPLAY CO., LTD., Yongin-si (KR)

(72) Inventors: Kangwoo LEE, Seoul (KR); Yongkyu KANG, Hwaseong-si (KR); Seulgi KIM, Seoul (KR); Sangchul BYUN, Anyang-si (KR); Younghye SON, Yongin-si (KR)

(21) Appl. No.: 16/136,391

(22) Filed: Sep. 20, 2018

(30) Foreign Application Priority Data
Oct. 11, 2017 (KR) 10-2017-0130040

(51) Int. Cl. G09G 3/32; F21V 8/00; G02B 5/20

(52) U.S. Cl. CPC G09G 3/32; G02B 6/0031; G02B 5/20; G02B 6/0025; G02B 6/0073

(57) ABSTRACT

A backlight unit includes a light source unit which generates and emits light for displaying an image; a light guide plate which guides the light from the light source unit toward a display panel which displays the image with the light, the light guide plate including: a light incident surface which faces the light source unit and through which the light is incident into the light guide plate, an upper surface through which the light is emitted from the light guide plate to the display panel, and a lower surface which opposes the upper surface; a reflective sheet which faces the lower surface of the light guide plate; and an angular filter which transmits light of a predetermined angle to the light incident surface of the light guide plate, the angular filter between the light source unit and the light incident surface of the light guide plate.

This application claims priority to Korean Patent Application No. 10-2017-0130040, filed on Oct. 11, 2017, and all the benefits accruing therefrom under 35 U.S.C. § 119, the contents of which in their entirety are herein incorporated by reference.

### BACKGROUND

### 1. Field

Embodiments of the invention relate to a backlight unit, and more particularly, to a backlight unit having a structure in which a conventional optical sheet is omitted.

### 2. Discussion of the Related Art

Liquid crystal display (“LCD”) devices are display devices that may not generate and emit light therein and may be driven in an indirect light emission scheme in which a transmittance of light incident from an external light source is adjusted to display images. The LCD devices include a display panel and a backlight unit (“BLU”) which generates and supplies light to the display panel. The backlight units are classified into a direct-type backlight unit, an edge-type backlight unit and a corner-type backlight unit according to the position of light sources.

The edge-type backlight units include a light guide plate and a light source which is disposed on one side of the light guide plate, and a light emitted from the light source passes through the light guide plate to be incident to the display panel. In such a case, the edge-type backlight units may further include an optical sheet structure having plural individual sheets such as a reflective sheet, a diffusion sheet, a prism sheet and a protective sheet. The light guide plate serves to change a propagation direction of the light emitted from the light source to be directed toward the display panel. The reflective sheet may be disposed at the back of the light guide plate to reflect a light emitted toward the back of the light guide plate to be re-incident to the light guide plate, thereby substantially minimizing light loss. The diffusion sheet may serve to uniformly disperse the light incident thereto from the light guide plate. The prism sheet may serve to condense the incident light thereof using an optical pattern at a surface of the prism sheet to emit the condensed light toward the display panel. A protective sheet may be provided on the prism sheet to protect the prism sheet.

### SUMMARY

Embodiments of the invention may be directed to a backlight unit including a composite light guide plate in which an optical sheet is omitted as compared to a conventional backlight unit, which may improve a relatively high color reproduction ratio and realize a reduced thickness while substantially preventing a light leakage phenomenon.

According to an exemplary embodiment, a backlight unit includes a light source unit which generates and emits light for displaying an image; a light guide plate which guides the light from the light source unit toward a display panel which displays the image with the light, the light guide plate including: a light incident surface which faces the light source unit and through which the light is incident into the light guide plate, an upper surface through which the light is emitted from the light guide plate to the display panel, and a lower surface which opposes the upper surface; a reflective sheet which faces the lower surface of the light guide plate; and an angular filter which transmits light of a predetermined angle to the light incident surface of the light guide plate, the angular filter between the light source unit and the light incidence surface of the light guide plate.

The angular filter may include a relatively low refractive index layer and a relatively high refractive index layer which are alternately disposed with each other.

Each of the relatively low refractive index layer and the relatively high refractive index layer may have a thickness in a range from about ⅛ to about ½ of a light wavelength incident to the angular filter.

The relatively low refractive index layer may have a refractive index in a range from about 1.1 to about 1.4, and the relatively high refractive index layer may have a refractive index in a range from about 1.4 to about 1.8.

The light source unit, the light guide plate and the angular filter disposed therebetween may form a monolithic structure.

The light source unit may include a circuit board; a light emitting diode (“LED”) chip on the circuit board; and a sealing member which seals on the light emitting diode chip on the circuit board.

A portion of the sealing member may be disposed between the light emitting diode chip and the angular filter. The light source unit may further include a light conversion member embedded in the portion of the sealing member.

The light conversion member embedded in the portion of the sealing member may be between the light emitting diode chip and the angular filter.

The light conversion member may include: a red conversion portion which absorbs a blue light and emits a red light; and a green conversion portion which absorbs a blue light and emits a green light.

The light source unit may further include a reflective layer between the circuit board and the light emitting diode chip.

The backlight unit may include a first light output pattern on the upper surface of the light guide plate.

The first light output pattern may include a lenticular lens.

The backlight unit may further include a second light output pattern on the lower surface of the light guide plate.

The second light output pattern may include an asymmetric prism.

The asymmetric prism may include a first oblique side thereof closer to the light incident surface than a second oblique side thereof, the first oblique side having an angle in a range from about 75 degrees to about 90 degrees with respect to the lower surface of the light guide plate.

The light guide plate may further include a light opposing surface which opposes the light incident surface. The asymmetric prism may be provided in plurality along the lower surface of the light guide plate. A density of the asymmetric prisms increases as a distance from the light incident surface toward the light opposing surface increases.

The backlight unit may further include a light re-guide layer on the first light output pattern.

A refractive index of the light re-guide layer may be in a range from about 1.40 to about 1.50.

The reflective sheet may include a plurality of prisms having symmetric or asymmetric cross-sections.

According to an exemplary embodiment, a backlight unit includes: a light source unit which generates and emits light for displaying an image; a light guide plate which guides the light from the light source unit toward a display panel which displays the image with the light, the light guide plate including: a light incident surface which faces the light source unit and through which the light is incident into the light guide plate, an upper surface through which the light is emitted from the light guide plate, and a lower surface which opposes the upper surface; a reflective sheet which faces the lower surface of the light guide plate; and a light re-guide layer on the upper surface of the light guide plate, where the light re-guide layer reflects light emitted through the upper surface of the light guide plate toward the display panel back to the light guide plate.

The foregoing is illustrative only and is not intended to be in any way limiting. In addition to the illustrative embodiments and features described above, further embodiments and features will become apparent by reference to the drawings and the following detailed description.

### BRIEF DESCRIPTION OF THE DRAWINGS

A more complete appreciation of the invention will become more apparent by describing in detail embodiments thereof with reference to the accompanying drawings, where:

FIG. 1 is a cross-sectional view illustrating an exemplary embodiment of a backlight unit of a display device according to the invention;

FIG. 2 is an enlarged cross-sectional view of an exemplary embodiment of a light source unit of a backlight unit according to the invention;

FIG. 3 is a cross-sectional view illustrating an exemplary embodiment of a first light output pattern and a second light output pattern on a light guide plate of a backlight unit according to the invention;

FIG. 4A is a cross-sectional view illustrating an emission direction and an angle of a light incident into a light guide plate of a backlight unit and FIG. 4B is an enlarged cross-sectional view of portion A in FIG. 4A according to the invention;

FIG. 5 is a cross-sectional view for explaining light reflected by a reflective sheet of an exemplary embodiment of a backlight unit according to the invention;

FIG. 6 is a cross-sectional view for explaining light guided by a light re-guide layer of an exemplary embodiment of a backlight unit according to the invention; and

FIG. 7 is a cross-sectional view illustrating another exemplary embodiment of a backlight unit of a display device according to the invention.

### DETAILED DESCRIPTION

Embodiments will now be described more fully hereinafter with reference to the accompanying drawings. Although the invention may be modified in various manners and have several embodiments, embodiments are illustrated in the accompanying drawings and will be mainly described in the specification. However, the scope of the invention is not limited to the embodiments and should be construed as including all the changes, equivalents and substitutions included in the spirit and scope of the invention.

In the drawings, thicknesses of a plurality of layers and areas are illustrated in an enlarged manner for clarity and ease of description thereof. When a layer, area, or plate is referred to as being related to another element such as being “on” another layer, area, or plate, it may be directly on the other layer, area, or plate, or intervening layers, areas, or plates may be present therebetween. Conversely, when a layer, area, or plate is referred to as being related to another element such as being “directly on” another layer, area, or plate, intervening layers, areas, or plates are absent therebetween. Further when a layer, area, or plate is referred to as being related to another element such as being “below” another layer, area, or plate, it may be directly below the other layer, area, or plate, or intervening layers, areas, or plates may be present therebetween. Conversely, when a layer, area, or plate is referred to as being related to another element such as being “directly below” another layer, area, or plate, intervening layers, areas, or plates are absent therebetween.

The spatially relative terms “below,” “beneath,” “lower,” “above,” “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “physically and/or mechanically connected” to the other element, or “electrically connected” to the other element with one or more intervening elements interposed therebetween.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises,” “comprising,” “includes” and/or “including,” when used in this specification, specify the presence of stated features, integers, steps, operations, elements and/or components, but do not preclude the presence or addition of one or more other features, integers, steps, operations, elements, components and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10% or 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Some of the parts which are not associated with the description may not be provided in order to for example describe embodiments according to an embodiment and like reference numerals refer to like elements throughout the specification.

A conventional optical sheet structure having a plurality of individual sheets therein, has a problem in that the manufacturing process of a display device including such conventional optical sheet structure is complicated, achieving a thin film structure of the overall display device is quite difficult, and the manufacturing cost of the display device is relatively high. In order to solve these problem, a composite light guide plate structure has been developed for a backlight unit in which the conventional optical sheet structure is omitted. Even where a display device includes such a composite light guide plate structure, maintain luminance and uniformity of light supplied from the backlight unit to the display panel is desired.

However, in the composite light guide plate structure with a simple prism pattern and a stripe pattern, as a distance increases from a light incident surface of the light guide plate structure, maintaining uniform luminance may be difficult and moire may be undesirably visible at the display panel. Accordingly, there remains a need for a composite light guide plate structure for which a light guiding pattern thereof may be formed through a simple process and may maintain relatively high light condensation and high luminance.

Furthermore, in the composite light guide plate structure, light leakage may occur at a light incident portion at which the light source is disposed because a critical angle of an incident angle at which a light is incident from the light guide plate is unsatisfactory. Such light leakage may cause a problem of lowering light utilization efficiency within the display device.

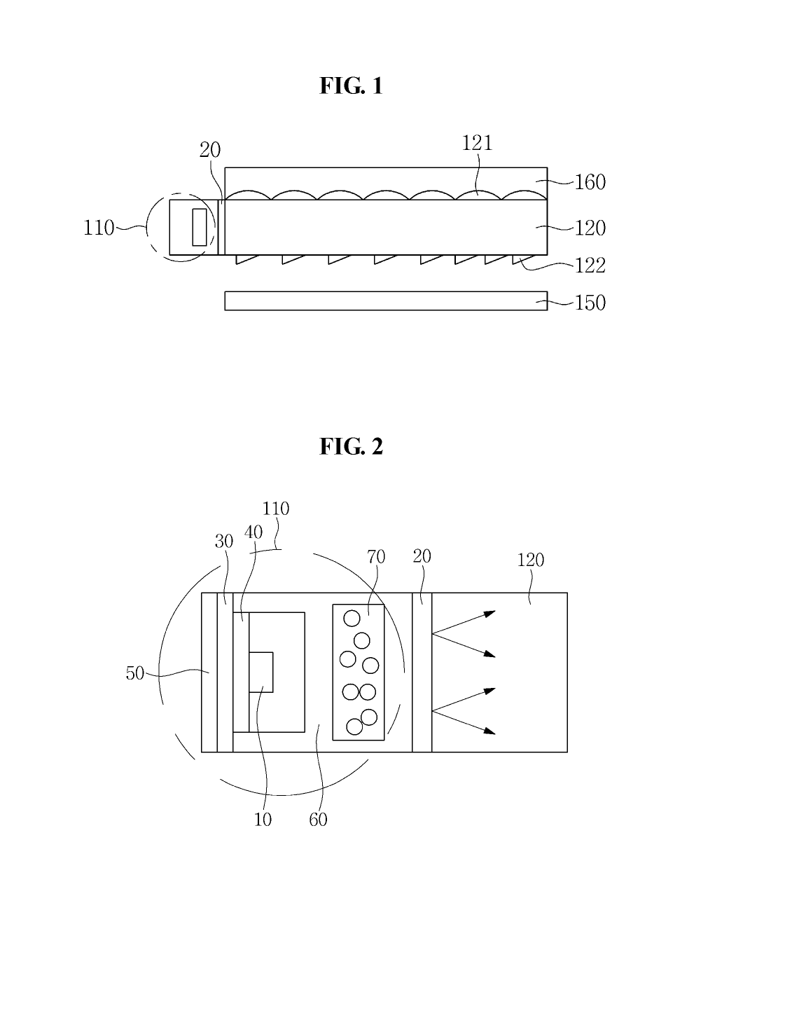

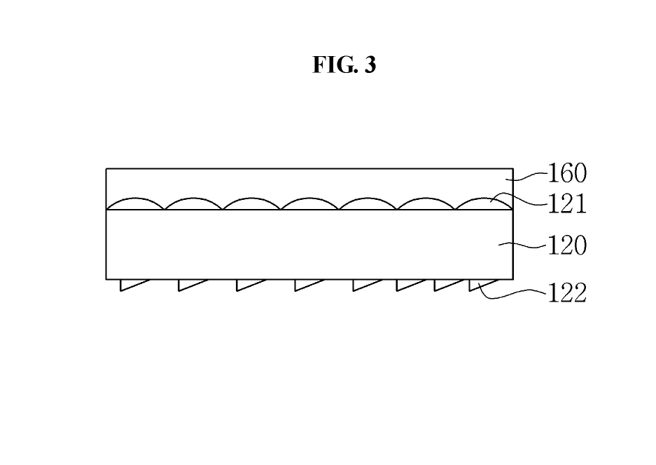

FIG. 1 is a cross-sectional view illustrating an exemplary embodiment of a backlight unit of a display device according to the invention, FIG. 2 is an enlarged cross-sectional view of an exemplary embodiment of a light source unit 110 of a backlight unit according to the invention, and FIG. 3 is a cross-sectional view illustrating an exemplary embodiment of a first light output pattern 121 and a second light output pattern 122 on a light guide plate 120 of a backlight unit according to the invention.

Referring to FIG. 1, a backlight unit according to an exemplary embodiment is an edge-type backlight unit including a light source unit 110 installed at a side surface of the backlight unit. The backlight unit may generally include the light source unit 110 which generates and emits light, a light guide plate 120 which scatters and uniformizes the light incident from the light source unit 110, a reflective sheet 150 which is disposed below a lower surface of the light guide plate 120 and reflects the light incident from the light source unit 110 and passed through the lower surface toward an upper surface of the light guide plate 120 on which a display panel such as a liquid crystal display (“LCD”) panel (not illustrated) is disposed, and an angular filter 20 which is disposed between the light source unit 110 and a light incident surface of the light guide plate 120 to allow a light of a predetermined angle to be incident to the light incident surface of the light guide plate 120.

The display panel, the backlight unit and components thereof are disposed in a plane defined by a first direction (e.g., horizontal in FIGS. 1-3) and a second direction (e.g., into the view of FIGS. 1-3) which crosses the first direction, without being limited thereto. The first and second directions may alternatively be respectively defined into the view and the horizontal direction of FIGS. 1-3. A thickness direction of the display panel, the backlight unit and components thereof is defined in a third direction (e.g., vertical in FIGS. 1-3).

As illustrated in FIG. 2, the light source unit 110 includes a light emitting diode (“LED”) chip 10, a circuit board 30, a reflective layer 40, a light blocking layer 50, a sealing member 60 such as glass and a light conversion member 70.

The LED chip 10 may generate and/or emit a blue light, for example. The LED chip 10 is disposed on the side of the light incident surface of the light guide plate 120 and emits a light at the front of the LED chip 10 in a direction toward the light guide plate 120. The LED chip 10 is a point light source or a linear light source which generates and/or emits light. The light from the point light source or the linear light source is incident into the light guide plate 120 through the light incident surface of the light guide plate 120. The light guide plate 120 guides and converts the incident light thereto into a surface light source and emits the surface light source light through a light emission surface which is the upper surface of the light guide plate 120 facing the display panel. As the display panel, the LCD panel (not illustrated) is disposed on and facing the upper surface of the light guide plate 120 in a display device such as the LCD device. Accordingly, the light in the form of a surface light source which is emitted through the upper surface of the light guide plate 120 is incident to the LCD panel.

The LED chip 10 is mounted on the circuit board 30 to be described below. According to an exemplary embodiment, the LED chip 10 is sealed by the glass 60 together with the circuit board 30 so as not to be exposed to outside the light source unit 110 such as to the outside air. In addition, the LED chip 10 receives an electric power from outside thereof through the circuit board 30 and may be driven according to a control signal applied from the outside. The control signal may be applied through the circuit board 30 to the LED chip 10 without being limited thereto.

The circuit board 30 includes circuit components on a base substrate or board. The circuit board 30 may be referred to a circuit board in which a (conductive) wiring layer and a (terminal) pad portion are disposed such as by patterning a conductive material layer on a base substrate. The circuit board 30 may be a single-sided printed circuit board (“PCB”), a double-sided PCB, a multilayer PCB, an intermediate via hole (“IVH”) PCB, a ball grid array (“BGA”) PCB, a rigid-flexible (“R-F”) PCB, a multi-chip module (“MCM”) PCB and the like.

The reflective layer 40 is disposed between the circuit board 30 and the LED chip 10 and may be implemented in the form of a film on the circuit board 30, for example. The reflective layer 40 re-reflects the light scattered by the angular filter 20 and the light conversion member 70 to the light incident surface of the light guide plate 120. As such, the reflective layer 40 may re-reflect a part of the light emitted from the LED chip 10 to provide the light to the light guide plate 120, thereby improving luminous efficiency. In addition, the reflective layer 40 includes a material having relatively high reflection efficiency to reduce light loss.

The light blocking layer 50 is disposed or formed on a back surface of the reflective layer 40 and substantially prevents a light from leaking through the corresponding area of the light source unit 110. The light blocking layer 50 may include an opaque material, for example, a black material. The light blocking layer 50 may include or be formed using a black ink. A width of the light blocking layer 50 along the horizontal direction in FIG. 2 may be constant.

The glass 60 is disposed at a first area of the light source unit 110 which is defined between the LED chip 10 and the angular filter 20 to seal the LED chip 10 so that the LED chip 10 may not be exposed to air outside the light source unit 110. Accordingly, even in the case where a relatively high output LED is applied as a light generating and/or emitting member within the light source unit 110, the light source unit 110 may maintain durability against relatively high temperature and moisture due to the sealing glass 60. Light may be transmittable through the glass 60.

The light conversion member 70 serves to convert a light of one wavelength (e.g., a single wavelength) which is emitted from the LED chip 10 into a light of various wavelength bands different from that of the emitted light. The light conversion member 70 is disposed between the LED chip 10 and the angular filter 20. In an exemplary embodiment, for example, the light conversion member 70 may be disposed on the LED chip 10 at the first area of the light source unit 110 which is defined between the LED chip 10 and the angular filter 20 and at which a portion of the glass 60 is disposed. The light conversion member 70 may be embedded in the glass 60 at the first area of the light source unit 110.

According to an exemplary embodiment, in order to join the light conversion member 70 with the glass 60 disposed at the first area defined between the LED chip 10 and the angular filter 20, a method of irradiating a laser such as a femto laser beam to an area between the light conversion member 70 and the glass 60 may be employed, but exemplary embodiments are not limited thereto.

The light conversion member 70 may include a resin including a phosphor. The phosphor is a substance which generates and/or emits fluorescence (e.g., fluorescent light) when irradiated with light or radiation. The phosphor emits a light having a unique color. In addition, the phosphor emits light at an entire area thereof regardless of a direction of the irradiated light incident thereto. According to an exemplary embodiment, the light conversion member 70 includes a red conversion portion and a green conversion portion. The red conversion portion absorbs a blue light of a single wavelength which is emitted from the LED chip 10 and emits a red light, and the green conversion portion absorbs the blue light and emits a green light. In such an exemplary embodiment, the red conversion portion and the green conversion portion respectively include phosphors which convert the blue light of a single wavelength into a light of a specific wavelength band, and include a plurality of red phosphors and green phosphors as described above.

Quantum dots (“QD”) may be used as the phosphor. In such an exemplary embodiment, because the quantum dots QD have excellent light emission characteristics, when a white light is emitted from the light source unit 110 using the quantum dots QD to generate light of specific wavelength bands, a color reproduction ratio of green light and red light may be improved as compared with a conventional white light generating/emitting LED.

According to an exemplary embodiment, since the LED chip 10 emits a (first) blue light, when the blue light emitted from the LED chip 10 passes through the light conversion member 70, the quantum dots absorb the blue light and convert the blue light into (second and third) lights of green and red wavelength bands. The green and red wavelength band lights they are mixed to realize a white light which is emitted from the light source unit 110.

Referring back to FIGS. 1 and 2, the angular filter 20 is disposed between the light source unit 110 and the light incident surface of the light guide plate 120.

In general, an angular filter is a filter including a material such as silicon or titanium and is used to obtain uniform light intensity distribution and/or uniform color distribution with respect to light emitted from the light source unit 110.

The angular filter 20 according to an exemplary embodiment has light transmittance and includes a relatively low refractive index layer and a relatively high refractive index layer which are alternately disposed. In such an exemplary embodiment, each of the relatively low refractive index layer and the relatively high refractive index layer includes a polymer material, and may include an anisotropic polyacrylonitrile (“PAN”)-based material or a non-anisotropic polyethylene acrylate (“PMA”)-based material. Herein, a material included in the angular filter 20 is not limited thereto. Each of the relatively low refractive index layer and the relatively high refractive index layer may have a thickness in a range from about ⅛ to about ½ of a light wavelength, but the thickness may be determined according to design. In an exemplary embodiment, thicknesses of the refractive index layers of the angular filter 20 may be in a range from about ⅛ to about ½ of a light wavelength incident to the angular filter 20. Thicknesses of the layers of the angular filter 20 may be taken along the horizontal direction of FIG. 2.

The relatively high refractive index layer may have a refractive index, for example, in a range from about 1.4 to about 1.8, and the relatively low refractive index layer may have a refractive index, for example, in a range from about 1.1 to about 1.4. In addition, a difference in refractive indices between the relatively high refractive index layer and the relatively low refractive index layer may be in a range from about 0.2 to about 0.4

In addition, according to an exemplary embodiment, at least a part of the light source unit 110 is joined with the light guide plate 120 so that the light source unit 110 and the light guide plate 120 are integrated (e.g., into a monolithic structure). To this end, the light source unit 110 may be joined with the light incident surface of the light guide plate 120 by laser welding with the angular filter 20 therebetween. Accordingly, the light source unit 110, the angular filter 20 and the light guide plate 120 are unitarily formed without an interface or space therebetween.

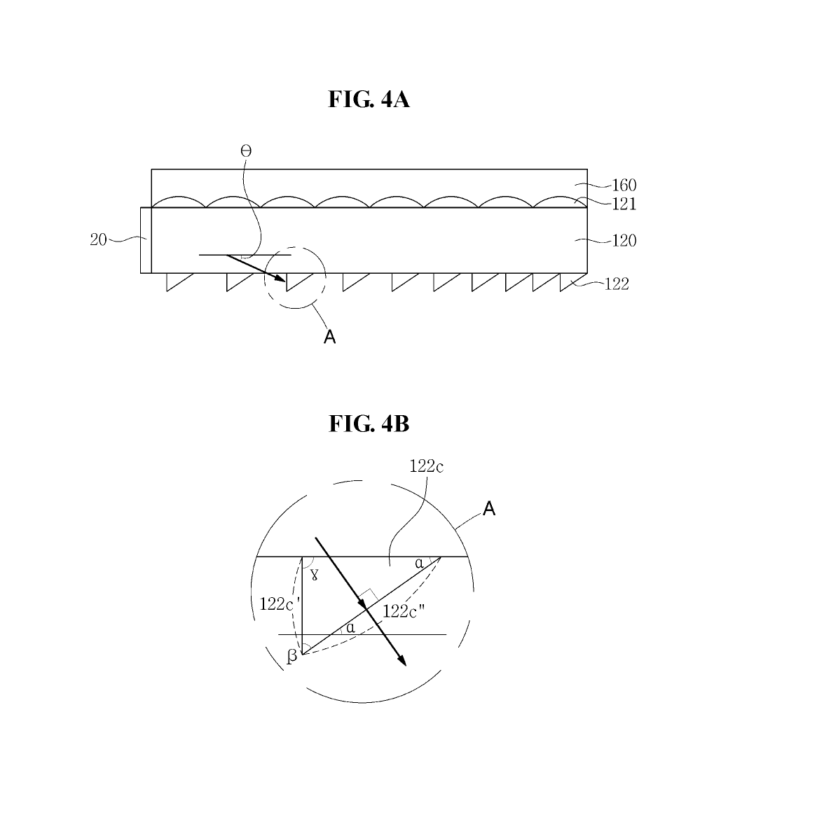

The angular filter 20 may only transmit a light incident at an incident angle θ of a predetermined angle, and may reflect a light incident at an incident angle θ other than the predetermined angle. In such an exemplary embodiment, a transmittance of the light passing through the angular filter 20 may vary depending on the incident angle θ. The incident angle θ may be defined as an angle of an incident light with respect to a normal line direction of a surface of the angular filter 20 (see FIGS. 4A and 4B).

In an exemplary embodiment, for example, the angular filter 20 may block the light incident at the incident angle θ of about 45 degrees (°) or more with respect to the angular filter 20 by about 50% to about 100%. In addition, the angular filter 20 may transmit the light incident at the incident angle θ of about 45° or more with respect to the angular filter 20 by about 0% to about 50%.

In an exemplary embodiment, the angular filter 20 may transmit most of light incident to a front surface of the angular filter 20, that is, a light incident at an incident angle θ of about 0° and a light incident an incident angle θ of a predetermined angle, while the angular filter 20 may block or reflect most of light incident at an incident angle θ other than the predetermined angle. As such, the angular filter 20 may unconstrainedly transmit or reflect the light incident at an arbitrary angle in a selective manner to improve a light utilization ratio.

As described above, the angular filter 20 serves to allow a light incident at a predetermined incident angle of the light emitted from the light source unit 110 to be incident to the light incident surface of the light guide plate 120.

Referring to FIGS. 1 and 3, the light guide plate 120 may include one of polymethyl methacrylate (“PMMA”) and polyethylene terephthalate (“PET”), which have good transmittance and are thermally stable. The light guide plate 120 includes a light incident (side) surface which faces the light source unit 110 and to which a light is incident to the light guide plate 120, a light opposing (side) surface opposing the light incident surface, an upper surface through which the light is emitted from the light guide plate 120, and a lower surface opposing the upper surface. Side surfaces of the light guide plate 120 each connect the upper and lower surfaces thereof to each other. The light incident (side) surface and the light opposing (side) surface are respectively defined by a side surface of the light guide plate 120.

The light guide plate 120 includes a light output pattern through which the light having passed through the angular filter 20 is emitted from the light guide plate 120 to the LCD panel. The light output pattern includes a first light output pattern 121 provided in plurality at the upper surface of the light guide plate and a second light output pattern 122 provided in plurality at the lower surface of the light guide plate 120. In addition, the light guide plate 120 may further include a light re-guide layer 160 on the first light output pattern 121.

A main body 120 of an overall light guiding member may define the upper and lower surfaces thereof, and the light output patterns 121 and 122 of the overall light guide plate may be considered disposed on such surfaces of the main body 120. The light output patterns 121 and 122 on the light guide plate 120 may be considered as defining the upper and/or lower surface of an overall light guiding member. In an exemplary embodiment, light output patterns 122 along with a portion of a surface (e.g., upper or lower) of the main body 120 may together define the overall (upper) light emission surface or the overall lower surface of the overall light guiding member. The light source unit 110, the light guide plate 120, the angular filter 20 disposed therebetween, the first light output pattern 121, the second light output pattern 122 and the light re-guide layer 160 may form a monolithic structure.

The first light output pattern 121 may include a lenticular lens. The plurality of first light output patterns 121 as a plurality of lenticular lenses diffuses a light emitted upwardly from a lower portion and an inner portion of the light guide plate 120. That is, the first light output patterns 121 emit the light incident from the light source unit 110, through the upper surface of the light guide plate 120 and uniformly to the LCD panel (not illustrated).

The second light output pattern 122 may include a prism. The second light output pattern 122 may lengthwise extend into the view of FIGS. 4A and 4B. The plurality of second light output patterns 122 as a plurality of prisms are substantially parallel to each other and spaced apart from each other along the light opposing surface (e.g., horizontal direction in FIGS. 4A and 4B). Each of the plurality of prisms may be an asymmetric prism. Each of the asymmetric prisms includes a first oblique side forming an angle γ in a range from about 70 degrees to about 90 degrees with the lower surface of the light guide plate 120 and a second oblique side forming an angle α which is less than the angle γ of the first oblique side with respect to the lower surface of the light guide plate 120. Detailed descriptions about each of the asymmetric prisms will be provided below with reference to FIGS. 4A and 4B.

In order to improve light uniformity, the asymmetric prisms are disposed so as to have a larger density as a distance from the light incident surface toward the light opposing surface decreases. The asymmetric prisms are disposed so as to have the larger density described above since the light emitted from the light source unit 110 becomes weaker as the distance from the light incident surface toward the light opposing surface increases. Accordingly, a larger degree of light condensation is provided further from the light incident surface. Accordingly, in order to supply uniform light to the LCD panel (not illustrated), an amount of light reflected through an asymmetric prism that is closest to the light incident surface is minimal, and an amount of light reflected through an asymmetric prism that is closest to the light opposing surface is maximal with an amount of light reflected through the asymmetric prisms increasing as the distance from the light incident surface increases.

Where a light guide plate has a conventional simple prism pattern, light uniformity may be relatively low and a moire phenomenon occurs as a distance from a light incident surface increases. However, in one or more exemplary embodiment according to the invention, as the first light output pattern 121 including a lenticular lens is disposed or formed at the upper surface of the light guide plate 120 and the second light output pattern 122 including an asymmetric prism is disposed or formed at the lower surface of the light guide plate 120, light uniformity may be relatively high as compared to that of the conventional light guide plate having the simple prism pattern. Accordingly, although the distance from the light incident surface increases, one or more exemplary embodiment according to the invention may have increased light uniformity and the manufacturing processes may be improved, the details of which will be described below with reference to the drawings.

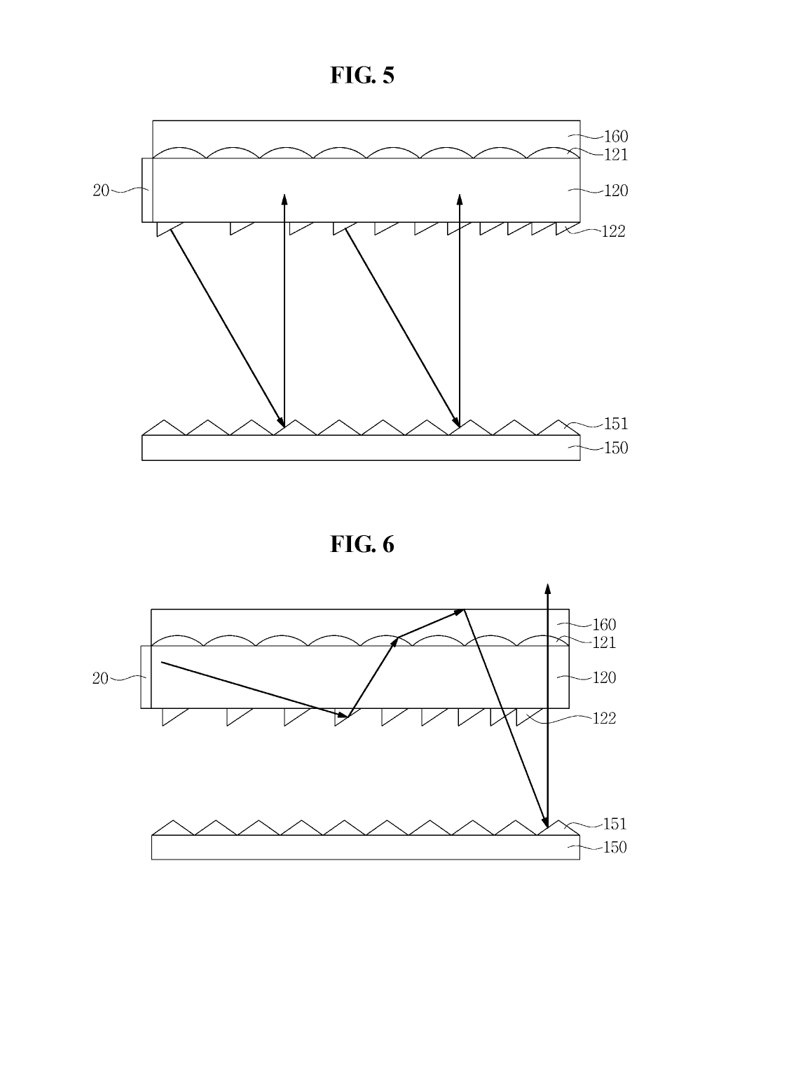

FIG. 4A is a cross-sectional view illustrating an emission direction and an angle of a light incident into the light guide plate 120 and FIG. 4B is an enlarged cross-sectional view of portion A in FIG. 4A according to the invention, FIG. 5 is a view for explaining light reflected by the reflective sheet 150 of an exemplary embodiment of a backlight unit according to the invention, and FIG. 6 is a cross-sectional view for explaining light guided by the light re-guide layer 160 of an exemplary embodiment of a backlight unit according to the invention.

According to an exemplary embodiment, the light emitted from the light source unit 110 passes through the angular filter 20. The light having passed through the angular filter 20 at a specific light angle θ is incident to the light incident surface of the light guide plate 120.

Referring to FIGS. 4A and 4B, a plurality of prisms, which are asymmetric prisms 122c, are disposed on the lower surface of the light guide plate 120. In such an exemplary embodiment, when a vertical cross-section of each of the asymmetric prisms 122c is enlarged, each asymmetric prism 122c has opposing oblique sides forming a vertex angle β. Herein, one of the opposing oblique sides forming the vertex angle β of each asymmetric prism 122c that is closer to the light incident surface of the light guide plate 120 is referred to as a first oblique side 122c′, and the other of the opposing oblique sides that is further away from the light incident surface of the light guide plate 120 is referred to as a second oblique side 122c″.

In the vertical cross-section of each asymmetric prism 122c, an angle γ between the first oblique side 122c′ and the lower surface of the light guide plate 120 is in a range from about 75° to about 90°. In an exemplary embodiment, the angle γ between the first oblique side 122c′ and the lower surface of the light guide plate 120 is about 90°.

In addition, a sum of an angle α between the second oblique side 122c″ and the lower surface of the light guide plate 120 and an angle θ between the first oblique side 122c′ and the second oblique side 122c″ may be in a range from about 90° to about 105°.

Referring to FIGS. 4A, 4B and 5, when a light having passed through the angular filter 20 is incident to the asymmetric prism at an angle of about 90-α°, the light is emitted from the asymmetric prism in a direction of a normal line with respect to the second oblique side 122c″ of the asymmetric prism as shown in FIG. 4B. In such an exemplary embodiment, when the incident light is incident to the asymmetric prism at an angle of θ and γ=90°, the incident angle θ of the light is substantially equal to the vertex angle β of the asymmetric prism 122c.

Referring to FIGS. 4A, 4B and 5, the light emitted from the asymmetric prism 122c in the direction of a normal line with respect to the second oblique side 122c″ of each asymmetric prism 122c is incident to the reflective sheet 150 below the light guide plate 120.

In an exemplary embodiment, the reflective sheet 150 includes a prism 151 provided in plurality having symmetric or asymmetric cross-sections. An interior angle of a vertical cross-section of each of the prisms 151 may be designed differently depending on a thickness of, a refractive index of and/or a material included in the light guide plate 120 from which light is emitted to the reflective sheet 150.

A main body 150 of an overall reflecting member may define the upper and lower surfaces thereof, and the prisms of the overall reflecting member may be considered disposed on an upper surface of the main body 150. The prisms 151 on the reflective sheet 150 may be considered as defining the upper surface of an overall reflecting member.

In addition, each of the plurality of prisms 151 reflects a light emitted downwardly from the light guide plate 120 back toward the light guide plate 120. In order to improve reflection efficiency of the light reflected into the light guide plate 120 from the reflective sheet 150, the prisms 151 may include a reflective material such as aluminum may on a surface thereof. The plurality of prisms 151 may further improve reflection and condensation efficiency of the light reflected by the reflective sheet 150.

In an exemplary embodiment, referring to FIGS. 4A, 4B and 6, when the light incident through the angular filter 20 is incident to the asymmetric prism 122c at an angle less than about 90-α°, the light is totally reflected from the second oblique side 122c″ of the asymmetric prism.

In such an exemplary embodiment, when the incident light is incident to the asymmetric prism at an angle of θ and γ=90°, the incident angle θ of the light is not equal to the vertex angle β of the asymmetric prism 122c.

In an exemplary embodiment, for example, when the incident angle θ of the light is less than the vertex angle β of each asymmetric prism 122c, a light incident to the angular filter 20 at a predetermined incident angle θ is totally reflected by the second oblique side 122c″ of the asymmetric prism.

The light totally reflected by the second oblique side 122c″ of the asymmetric prism 122c is emitted from the second light output pattern 122 toward the upper surface of the light guide plate 120.

According to an exemplary embodiment, the light re-guide layer 160 is disposed on the upper surface of the light guide plate 120. According to an exemplary embodiment, the light re-guide layer 160 is disposed on the first light output pattern 121 which is at the upper surface of the light guide plate 120. The light re-guide layer 160 may have a refractive index of about 1.40 or more and less than about 1.50. The light re-guide layer 160 may be considered a relatively low refractive index layer.

The light re-guide layer 160 may include one of a fluorine-based transparent polymer resin, magnesium fluoride, a silicon-based resin and silicon oxide.

Referring again to FIG. 6, the light re-guide layer 160 totally reflects a part of the light emitted at the upper surface of the light guide plate 120 to direct the light back to the reflective sheet 150 below the light guide plate 120. More specifically, the light re-guide layer 160 refracts the light incident from the first light output pattern 121, which is at the upper surface of the light guide plate 120, at a boundary between the first light output pattern 121 and the light re-guide layer 160, and then totally reflects the light once again at an upper surface of the light re-guide layer 160 back to the reflective sheet 150. Then, the reflective sheet 150 reflects the light which is totally reflected by the light re-guide layer 160 back towards the upper surface of the light guide plate 120.

As described above, according to an exemplary embodiment, by disposing the first light output pattern 121 and the light re-guide layer 160 at the upper surface of the light guide plate 120, thus re-guiding uncondensed light back to the light guide plate 120, relatively high light condensation and high luminance may be maintained and efficiency of the light supplied to the LCD panel may be further improved as compared to the case where only an air layer is defined above the light guide plate 120.

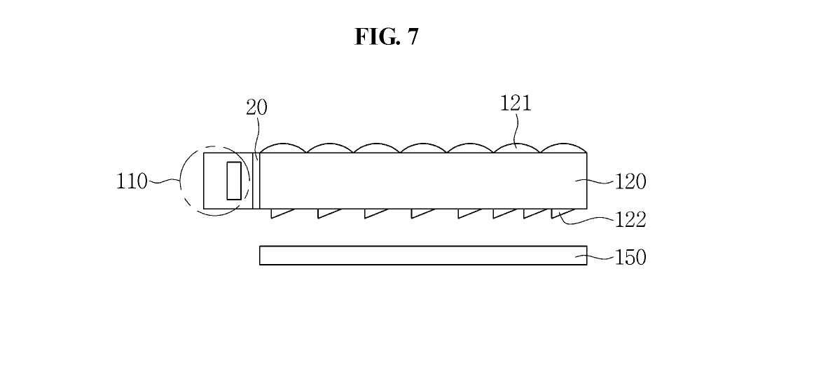

FIG. 7 is a cross-sectional view illustrating another exemplary embodiment of a backlight unit of a display device according to the invention.

In an exemplary embodiment, referring to FIG. 7, a backlight unit according to another exemplary embodiment has a structure in which the light re-guide layer 160 of FIG. 1 is removed. In such an exemplary embodiment, the backlight unit may generally include a light source unit 110 which generates and emits light, a light guide plate 120 which scatters and uniformizes the light incident from the light source unit 110, and a reflective sheet 150 which is disposed on a lower surface of the light guide plate 120 and reflects the light incident from the light source unit 110 toward an upper surface of the light guide plate 120 on which a display panel such as an LCD panel (not illustrated) is disposed. In such an exemplary embodiment, a first light output pattern 121 is provided in plurality disposed on the upper surface of the light guide plate 120, and a second light output pattern 122 is provided in plurality disposed on the lower surface of the light guide plate 120.

As illustrated in FIG. 7, although the light re-guide layer 160 is absent at the upper surface of the light guide plate 120, if an optimum thickness and an optimum material are designed for the light guide plate 120, efficiency of the light supplied to the LCD panel may be improved as an exemplary embodiment in which the light re-guide layer 160 is provided.

As set forth hereinabove, according to one or more exemplary embodiments, a backlight unit may reduce an overall thickness of a display device such as to achieve slimness of an LCD device by removing an optical sheet used in a conventional backlight unit and joining at least a portion of a light source unit with a light guide plate.

Further, according to one or more exemplary embodiments, the backlight unit includes an angular filter between the light source unit and a light incident surface of the light guide plate, and thereby the display characteristics of the LCD device may be improved.

In addition, in the backlight unit according to one or more exemplary embodiments, as a first light output pattern including a lenticular pattern lens is disposed on an upper surface of the light guide plate and a second light output pattern including an asymmetric prism is disposed on a lower surface of the light guide plate, the limit of manufacturing processes due to an increase of a light guide distance is improved and light uniformity is improved.

In addition, in the backlight unit according to one or more exemplary embodiments, a light re-guide layer is disposed on the first light output pattern which is disposed on the upper surface of the light guide plate in order to re-guide a light that is not condensed by the light guide plate, and thereby a degree of light condensation toward the front is improved and light uniformity may be improved.

While the invention has been illustrated and described with reference to the embodiments thereof, it will be apparent to those of ordinary skill in the art that various changes in form and detail may be made thereto without departing from the spirit and scope according to an embodiment.

What is claimed is:

1. A backlight unit comprising:
a light source unit which generates and emits light for displaying an image;
a light guide plate which guides the light from the light source unit toward a display panel which displays the image with the light, the light guide plate comprising:
a light incident surface which faces the light source unit and through which the light is incident into the light guide plate,
an upper surface through which the light is emitted from the light guide plate to the display panel, and
a lower surface which opposes the upper surface;
a reflective sheet which faces the lower surface of the light guide plate; and
an angular filter which transmits light of a predetermined angle to the light incident surface of the light guide plate, the angular filter between the light source unit and the light incident surface of the light guide plate.

2. The backlight unit of claim 1, wherein the angular filter comprises a first refractive index layer and a second refractive index layer having different refractive indices from each other and alternately disposed with each other.

3. The backlight unit of claim 2, wherein each of the first refractive index layer and the second refractive index layer of the angular filter has a thickness in a range from about ⅛ to about ½ of a light wavelength incident to the angular filter.

4. The backlight unit of claim 3, wherein
the first refractive index layer has a refractive index in a range from about 1.1 to about 1.4, and
the second refractive index layer has a refractive index in a range from about 1.4 to about 1.8.

5. The backlight unit of claim 1, wherein the light source unit, the light guide plate and the angular filter disposed therebetween have a monolithic structure.

6. The backlight unit of claim 1, wherein the light source unit comprises:
a light emitting diode chip which generates and emits the light;
a circuit board on which the light emitting diode chip is disposed; and
a light transmitting sealing member which seals the light emitting diode chip on the circuit board.

7. The backlight unit of claim 6, wherein
a portion of the light transmitting sealing member is disposed between the light emitting diode chip and the angular filter, and
the light source unit further comprises a light conversion member embedded within the portion of the light transmitting sealing member.

8. The backlight unit of claim 7, wherein the light conversion member embedded within the portion of the light transmitting sealing member is between the light emitting diode chip and the angular filter.

9. The backlight unit of claim 8, wherein the light conversion member comprises:
a red conversion portion which absorbs a blue light and emits a red light; and
a green conversion portion which absorbs a blue light and emits a green light.

10. The backlight unit of claim 6, wherein the light source unit further comprises a reflective layer between the circuit board and the light emitting diode chip.

11. The backlight unit of claim 1, comprising a first light output pattern on the upper surface of the light guide plate.

12. The backlight unit of claim 11, wherein the first light output pattern comprises a lenticular lens.

13. The backlight unit of claim 1, further comprising a second light output pattern on the lower surface of the light guide plate.

14. The backlight unit of claim 13, wherein the second light output pattern comprises an asymmetric prism.

15. The backlight unit of claim 14, wherein the asymmetric prism of the second light output pattern on the lower surface of the light guide plate comprises:
two oblique sides each extending from the lower surface of the light guide plate, and
among the two oblique sides, the oblique side closer to the light incident surface of the light guide plate having an angle in a range from about 75 degrees to about 90 degrees with respect to the lower surface of the light guide plate.

16. The backlight unit of claim 15, wherein
the light guide plate further comprises a light opposing surface which opposes the light incident surface,
the asymmetric prism of the second light output pattern is provided in plurality along the lower surface of the light guide plate, and
a density of the asymmetric prisms increases as a distance from the light incident surface toward the light opposing surface increases.

17. The backlight unit of claim 11, further comprising a light re-guide layer on the first light output pattern, wherein the light re-guide layer reflects light emitted from the first light output pattern toward the display panel back to the first light output pattern.

18. The backlight unit of claim 17, wherein a refractive index of the light re-guide layer is in a range from about 1.40 to about 1.50.

19. The backlight unit of claim 1, wherein the reflective sheet comprises a plurality of prisms having symmetric or asymmetric cross-sections, wherein the plurality of prisms reflects light emitted from the lower surface of the light guide plate toward the reflective sheet back to the light guide plate.

20. A backlight unit comprising:
a light source unit which generates and emits light for displaying an image;
a light guide plate which guides the light from the light source unit toward a display panel which displays the image with the light, the light guide plate comprising:
a light incident surface which faces the light source unit and through which the light is incident into the light guide plate,
an upper surface through which the light is emitted from the light guide plate, and
a lower surface which opposes the upper surface;
a reflective sheet which faces the lower surface of the light guide plate; and
a light re-guide layer on the upper surface of the light guide plate, wherein the light re-guide layer reflects light emitted through the upper surface of the light guide plate toward the display panel back to the light guide plate.
